(19) United States
(12) Patent Application Publication
(10) Pub. No.: US 2009/0294621 A1
(43) Pub. Date: Dec. 3, 2009

(54) SLIDE RAIL ASSEMBLY

(75) Inventors: Mo-Ming Yu, Shenzhen City (CN); Hai-Chen Zhou, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng, Taipein Hsien (TW)

(21) Appl. No.: 12/233,837

(22) Filed: Sep. 19, 2008

(30) Foreign Application Priority Data
May 30, 2008 (CN) 200810301854.8

(51) Int. Cl. F16M 13/00

(52) U.S. Cl. 248/429

(57) ABSTRACT

A slide rail assembly capable of being mounted to a chassis with an anchor member extending from a sidewall thereof includes a first rail, a retaining member, and a releasing member. The first rail includes a mounting slot defined therein and configured to slidably receive the anchor member. The retaining member includes a first end secured to the first rail and a retaining hole defined therein near a second end. The retaining hole is configured to retain the anchor member and for preventing the anchor member from exiting the mounting slot. The releasing member includes a wedge-shaped block. The block is capable of being slidably inserted between the retaining member and the first rail to disengage the anchor member from the retaining hole.

### BACKGROUND

1. Field of the Invention

The present invention relates to slide rail assemblies, and more particularly to a slide rail assembly adapted to be mounted on a chassis without the use of tools.

2. Description of Related Art

A typical slide rail assembly for a server chassis and a rack includes an outer slide rail mounted to the rack, an inner slide rail mounted to the chassis, and an intermediate slide rail mounted between the outer and inner slide rails. The intermediate slide rail is extendable relative to the outer slide rail, and the inner slide rail is extendable relative to the intermediate slide rail, so that the chassis can be extended a distance out from the rack. The inner rail is typically secured to the chassis using a plurality of screws. Therefore, a tool such as a screwdriver is needed for installing and detaching the slide rail, which is tedious and time consuming.

### BRIEF DESCRIPTION OF THE DRAWINGS

FIG. 1 is a partial exploded, isometric view of an embodiment of a slide rail assembly and a chassis;

FIG. 2 is a partial assembled view of the chassis and the slide rail assembly of FIG. 1;

FIGS. 3 to 5 are partial cross-sectional views of the chassis and the slide rail assembly of FIG. 2 in different statuses.

### DETAILED DESCRIPTION

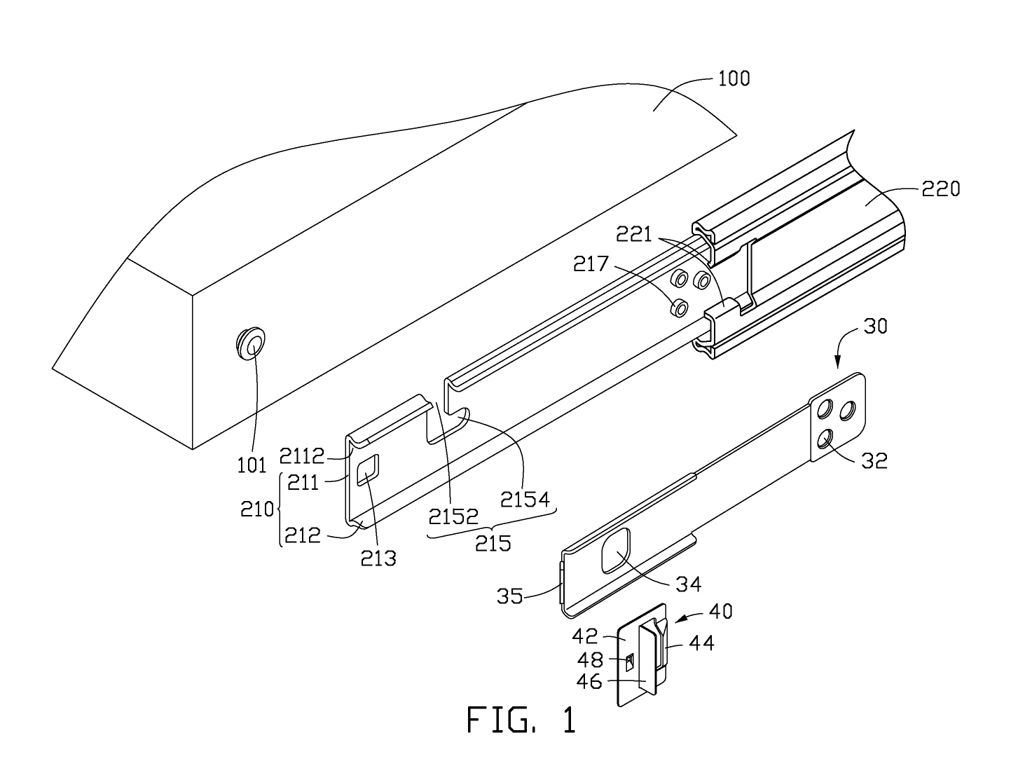

Referring to FIG. 1, an embodiment of a slide rail assembly is configured for mounting to a server chassis 100. The slide rail assembly includes a first rail 210 capable of mating with the chassis 100, a second rail 220 slidably engaged with the first rail 210, a retaining member 30 attached to the first rail 210, and a releasing member 40 slidably installed on the first rail 210.

The chassis 100 includes a mushroom-shaped anchor member 101 extending from a sidewall of the chassis 100. The anchor member 101 includes a neck portion and a head portion with a diameter greater than a diameter of the neck portion.

In the present embodiment, the first rail 210 is an inner rail, the second rail 220 is an intermediate rail. The first rail 210 includes a sidewall 211 and a pair of wings 212 perpendicularly extending perpendicularly from opposite edges of the sidewall 211. A pair of guiding slots 2112 is respectively defined between the wings 212 and sidewalls 2111. A limiting hole 213, a L-shaped mounting slot 215 and a plurality of coupling portions 217 are sequentially arranged at a front end of the sidewall 211 along a longitudinal direction of the first rail 210. The mounting slot 215 includes an accessing portion 2152 and a positioning portion 2154 communicating with each other. The accessing portion 2152 extends along a transverse direction of the first rail 210 and the positioning portion 2154 extends along a longitudinal direction of the first rail 210. The coupling portions 217 protrude from an outside surface of the sidewall 211. The second rail 220 includes a pair of spaced contacting portions 221 formed at a front end thereof.

The retaining member 30 includes a resilient plate with a plurality of coupling holes 32 defined in a first end corresponding to the coupling portions 217 of the first rail 210, and a retaining hole 34 defined in a second end. A guiding tab 35 slantingly extends from an edge near the retaining hole 34.

The releasing member 40 includes a sliding portion 42, an operating portion 46 extending perpendicularly from a center part of the sliding portion 42, a bridge-shaped limiting tab 48 protruding inwards from the sliding portion 42, and a wedge-shaped block 44 protruding outward from the sliding portion 42. The limiting tab 48 and the block 44 are respectively located at opposite sides of the operating portion 46.

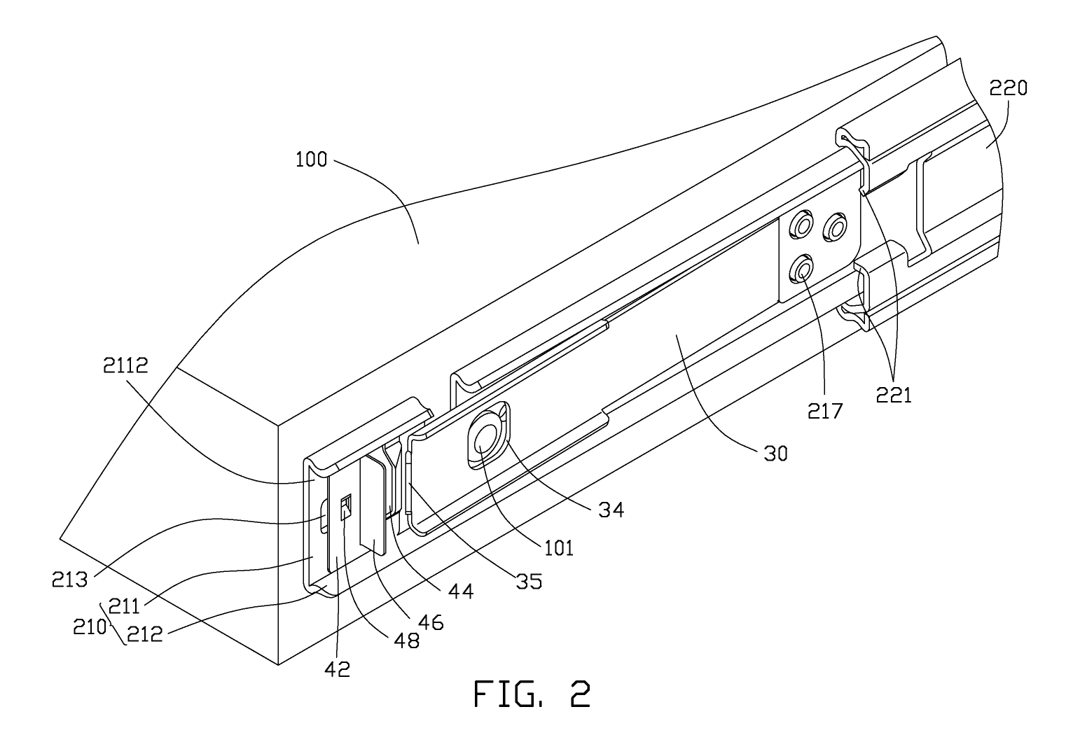

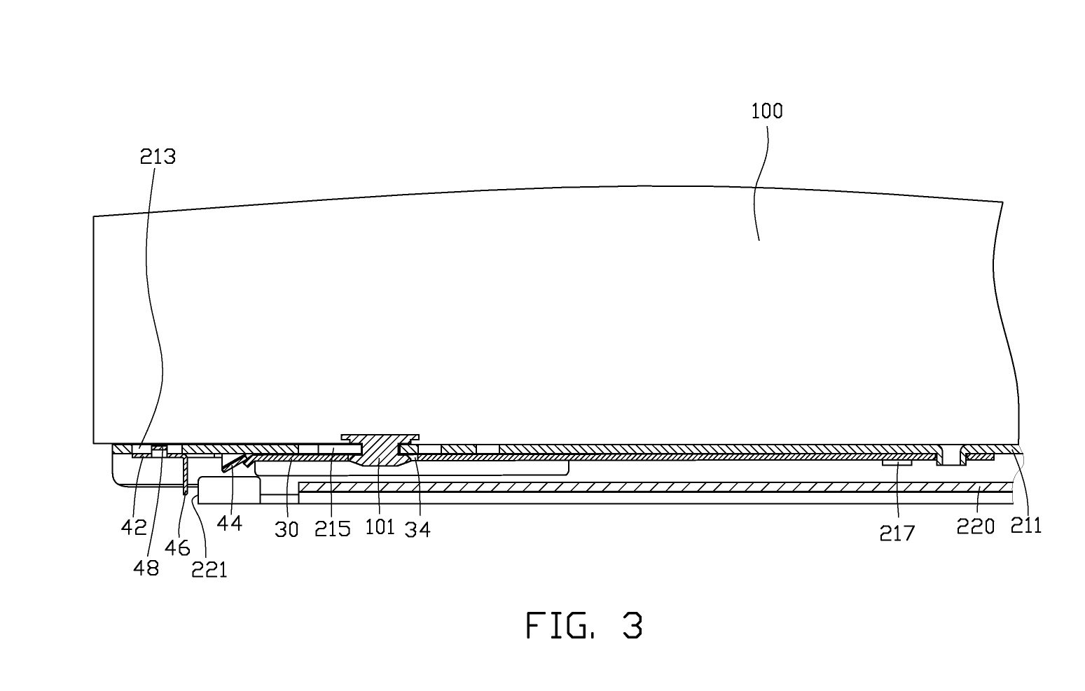

Referring also to FIGS. 2 and 3, in assembly, the coupling portions 217 of the first rail 20 are correspondingly fixed in the coupling holes 32 to secure the first end of the retaining member 30 to the first rail 210. The retaining member 30 abuts against the sidewall 211, and the retaining hole 34 is aligned with the mounting slot 215. Opposite edges of the sliding portion 42 are slidably engaged in the guiding slots of the first rail 210. The block 44 faces the second end of the retaining member 30. The limiting tab 48 is engaged in the limiting hole 213 so that the releasing member 40 can slide in a range limited by the limiting hole 213.

The slide rail assembly is attached to the chassis 100 by sliding the neck portion of the anchor member 101 in the accessing portion 2152. The head portion of the anchor member 101 engages with a side of the retaining member 30 to push and deform the second end of the retaining member 30 away from the first rail 210. The neck of the anchor member 101 slides into the positioning portion 2154 until the head of the anchor member 101 is aligned with the retaining hole 34 and the retaining member 30 is restored. The head portion of the anchor member 101 extends into the retaining hole 34 and is retained in the retaining hole 34, thereby preventing the anchor member 101 from exiting from the mounting slot 215 and securing the first rail 210 to the chassis 100.

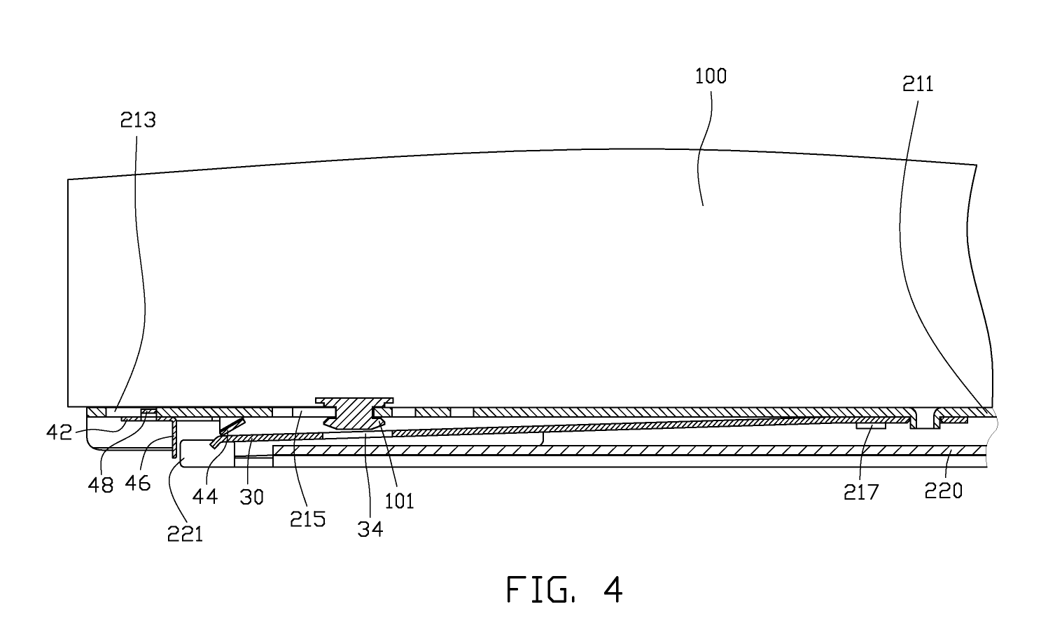

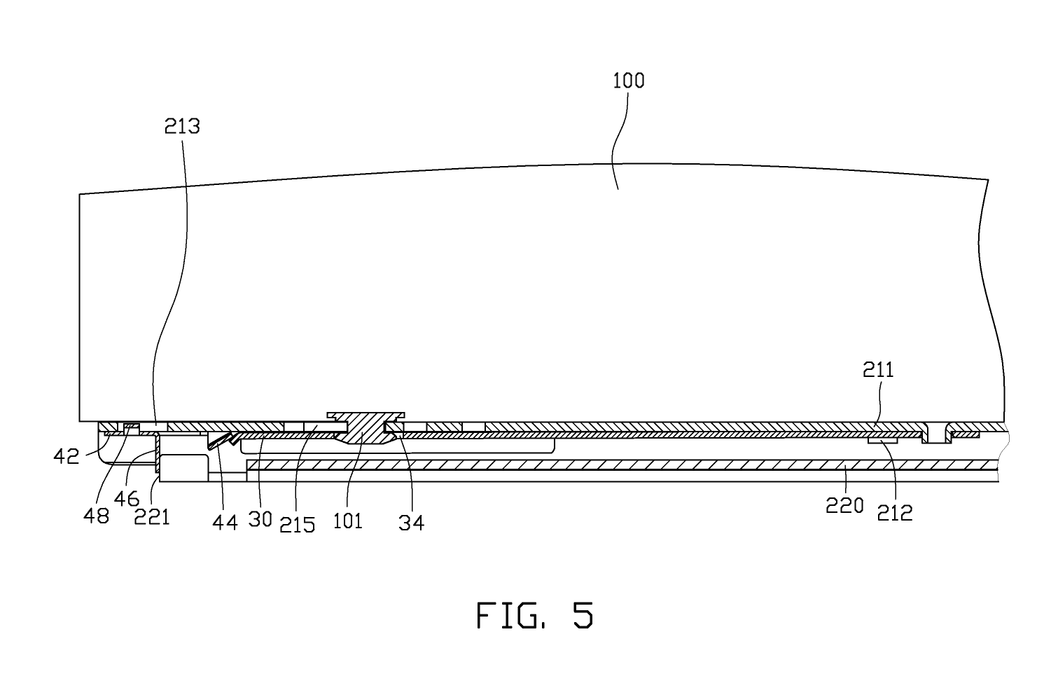

Referring also to FIG. 4, the first rail 210 is detached from the chassis 100 by sliding the releasing member 40 towards the retaining member 30. The block 44 is inserted between the retaining member 30 and the sidewall 211 of the first rail 210 while guided by the guiding tab 35, causing the second end of the retaining member 30 to be pried away from the first rail 210. The retaining member 30 is deformed and disengaged from the anchor member 101. The chassis 100 can be moved so that the anchor member 101 slides out from the mounting slot 215.

In one embodiment, when the first rail 210 is detached from the chassis 100, the releasing member 40 may be manipulated to slide away from the retaining member 30, so that the retaining member 30 is restored and the first rail 210 is ready for attachment to the chassis 100. A mechanism may be provided to automatically prepare the slide rail 210 for attachment to the chassis 100. When the first rail 210 is retracted into the second rail 220 and the releasing member 40 does not slide away from the retaining member 30, the contacting portion 221 abuts against the operating portion 46 and forces the releasing member 40 to slide away from the retaining member 30. Thus, the retaining member 30 is restored and slide rail 210 is ready for attachment to the chassis 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A slide rail assembly capable of being mounted to a chassis with an anchor member extending from a sidewall thereof, the slide rail assembly comprising:
a first rail defining a mounting slot therein configured for slidably receiving the anchor member of the chassis;
a retaining member having a first end secured to the first rail and a retaining hole defined near a second end, wherein the retaining hole is configured for retaining the anchor member and preventing the anchor member from exiting the mounting slot; and
a releasing member comprising a wedge-shaped block capable of being slidably inserted between the retaining member and the first rail for disengaging the anchor member from the retaining hole of the retaining member.

2. The slide rail assembly of claim 1, wherein the retaining member comprises a guiding tab formed on the second end for guiding the block between the retaining member and the first rail.

3. The slide rail assembly of claim 1, wherein the mounting slot is L-shaped and comprises:
an accessing portion configured for the anchor member to slide into the mounting slot; and
a positioning portion communicating with the accessing portion, wherein the positioning portion is configured to retain the anchor member.

4. The slide rail assembly of claim 1, wherein the releasing member further comprises a sliding portion; the first rail comprises a sidewall and a pair of wings perpendicularly extending from opposite edges of the sidewall; a pair of guiding slots are defined in the first rail between the pair of wings and sidewall; the guiding slots are configured for the slide portion to slide along the first rail.

5. The mounting mechanism of claim 4, wherein the block is formed on an end of the sliding portion and faces the retaining member.

6. The slide rail assembly of claim 4, wherein the first rail defines a limiting hole; the releasing member further comprises a limiting tab protruding from the sliding portion; the releasing member is configured to be movably received in the limiting hole.

7. The slide rail assembly of claim 4, further comprising a second rail slidably engaged with the first rail, wherein the releasing member further comprises an operating portion; when the first rail slides towards the second rail, the second rail abuts against the operating portion of the releasing member and forces the releasing member to slide away from the retaining member.

8. The slide rail assembly of claim 7, wherein an operating portion extends perpendicularly from a center part of the sliding portion.

9. The slide rail assembly of claim 8, wherein the retaining member further comprises a contacting portion positioned at an edge near the retaining hole configured to abut against the operating portion.

10. A method for attaching and detaching a slide rail assembly from a chassis, wherein the slide rail assembly comprises a first rail defining a mounting slot and a second rail slidably engaged with the first rail; the chassis comprises an anchor member extending therefrom received in the mounting slot; the method comprising:
(a) providing a retaining member having a first end secured to the first rail and a retaining hole defined near a second end, the retaining hole engaging with the anchor member, and a releasing member slidably engaged on the first rail and comprising a wedge-shaped block;
(b) forcing the releasing member to engage the block between the retaining member and the first rail, until the anchor member of the chassis is released from the retaining hole; and
(c) moving the chassis to slide the anchor member out from the mounting slot.

11. The method of claim 10, wherein the releasing member comprises an operating portion; the method further comprises sliding the first rail towards the second rail causing the second rail to abut against the operating portion and force the releasing member to slide away from the retaining member after the anchor member is out from the mounting slot.
